(19) United States
(12) Patent Application Publication
(10) Pub. No.: US 2018/0300333 A1
(43) Pub. Date: Oct. 18, 2018

(54) FEATURE SUBSET SELECTION AND RANKING

(71) Applicant: General Electric Company, Schenectady, NY (US)

(72) Inventors: Tianyi WANG, Clifton Park, NY (US); Weizhong YAN, Clifton Park, NY (US)

(21) Appl. No.: 15/486,627

(22) Filed: Apr. 13, 2017

(51) Int. Cl. G06F 17/30; G06Q 10/06

(52) U.S. Cl. CPC G06F 17/3053; G06Q 10/067; G06Q 10/063

(57) ABSTRACT

The example embodiments are directed to a system and method for feature subset selection and ranking. In an example, the method includes executing a base routine on a candidate set of features to generate an initial solution set, identifying a plurality of initial exclusions sets for the initial solution set, generating a plurality of partial candidates sets of the candidate set based on the initial exclusion sets, executing the base routine on the partial candidate sets to discover a plurality of additional solution sets, and combining the discovered solutions sets to generate a combined set of feature subsets. The method also includes determining a ranking for each feature subset in the combined set of feature subsets and outputting information concerning the determined rankings for display.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles, and the like. As another example, assets may include healthcare machines and equipment that aid in diagnosing patients such as imaging devices (e.g., X-ray or MRI systems), monitoring devices, and the like. The design and implementation of these assets often considers both the physics of the task at hand, as well as the environment in which such assets are configured to operate.

Low-level software and hardware-based controllers have long been used to drive machine and equipment assets. However, the rise of inexpensive cloud computing, increase in sensor capabilities, decrease in sensor costs, and the proliferation of mobile technologies have generated new opportunities for creating novel industrial and healthcare based assets with improved sensing technology and which are capable of transmitting data that can then be distributed throughout a network. As a result, there are new opportunities to enhance the business value of some assets through the use of novel industrial-focused hardware and software.

When developing data-driven analytics solutions using data such as time-series data from machine and equipment assets, or any other kind of data, good features can be important to predictive models and can greatly influence results that are going to be achieved by these models. In these examples, a feature refers to a piece of information that might be useful for prediction. Any attribute could be a feature if it is useful to the model or in solving a problem associated with the model. In most cases, the better the features, the better the results/analysis of the model. Therefore, discovering the right features can produce simpler more flexible models that often yield better results. However, identifying optimal features for a given data or problem can be very difficult because there are often thousands of possible features that can be calculated using various algorithms and variables. Accordingly, what is needed is a tool for improving feature discovery.

### SUMMARY

Embodiments described herein improve upon the prior art by providing a non-exhaustive, approximate approach to feature subset ranking which can directly identify many unique high-ranking subsets while avoiding or wasting resources on evaluations of low-ranking subsets. The feature subset ranking process described herein is a non-exhaustive, non-randomized method for feature subset ranking, which can efficiently identify multiple unique high-potential subsets through a small number of search iterations. The enhanced feature selection may be implemented within a larger feature discovery process which may identify features that can be input into one or more analytics which can be used to monitor and control an asset. In some aspects, the method can be implemented as software that is deployed on a cloud platform such as an Industrial Internet of Things (IIoT).

In an aspect of an embodiment, provided is a method for ranking feature subsets including executing a base routine on a candidate set of features to discover an initial feature subset, also referred to as a solution set, and generating a plurality of initial exclusions sets from the initial solution set. The method also includes generating a plurality of partial candidates sets of the candidate set based on the plurality of initial exclusion sets, executing the base routine on the plurality of partial candidate sets to discover a plurality of additional solution sets, and combining the discovered solutions sets to generate a combined set of unique feature subsets, and determining a ranking for each feature subset and outputting information concerning the determined rankings for display on a display device.

In an aspect of another embodiment, provided is computing system including a storage device, a processor configured to execute a base routine on a candidate set of features to generate an initial solution set, and identify a plurality of initial exclusions sets for the initial solution set, wherein the processor is further configured to generate a plurality of partial candidates sets of the candidate set based on the plurality of initial exclusion sets, execute the base routine on the plurality of partial candidate sets to discover a plurality of additional solution sets, combine the discovered solutions sets to generate a combined set of unique feature subsets, and determine a ranking for each feature subset and output information concerning the determined rankings for display on a display device.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud-computing environment associated with industrial systems in accordance with an example embodiment.

FIG. 2 is a diagram illustrating an example of a feature discovery process in accordance with an example embodiment.

FIG. 3 is a diagram illustrating a feature subset selection and ranking process in accordance with an example embodiment.

FIG. 4 is a diagram illustrating a feature subset selection process in accordance with an example embodiment.

FIG. 5 is a diagram illustrating a method for selecting and ranking feature subsets in accordance with an example embodiment.

FIG. 6 is a diagram illustrating a computing device for selecting and ranking feature subsets in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown.

Traditionally, feature engineering has been a pure knowledge-based approach that is performed manually by domain experts, which is not only time-consuming, and thus not scalable, but also ineffective and limited. However, current feature engineering may incorporate domain knowledge to guide feature creation and selection while developing analytic models for real-world problems. In feature engineering, feature selection is not fully driven by analytic algorithms using quantitative criteria as is in machine learning research, but instead mixed with human judgement using various qualitative criteria that are hard to derive from data, such as whether the selected features have interpretable physical meanings to the problem in question. For the most part, human experts are the only means capable, and responsible to make the final decision about feature selection, whereas feature selection algorithms only serve as a decision support tool.

Feature selection (e.g., variable selection) has often been approached in one of two ways, feature ranking or feature subset selection. Feature ranking is typically a univariate approach which ranks individual features based on certain criteria. Feature subset selection (also referred to as model selection) is typically a multivariate approach which selects multiple features as a whole, also referred to as a feature subset, to build the best model. There are gaps, however, between both of these well-studied approaches.

Feature ranking is a good approach for investigating and identifying key factors of a problem, but it is not as effective as the feature subset selection approach in identifying a set of variables for building a good prediction model. For example, a variable that is not beneficial by itself can provide a significant performance improvement when taken into account with others, and two variables that are not beneficial by themselves can be useful together. On the other hand, the feature subset selection approach helps to build a good prediction model; however, the best feature subset discovered from feature subset selection may be sensitive to perturbations of experimental conditions, such as noise in data, selection of training samples, and initial conditions of the algorithm, causing the best feature subset obtained to be less likely to explain the true underlying process.

One of the causes of variance in feature subset selection is correlated features, also referred to as multicollinearity, in the data. Having multicollinearity in the data implies that there actually exists more than one feature subset that can best explain the underlying process, whereas the different expressions of the underlying process are essentially equivalent. Trying to find a single best solution for a problem with many equivalent alternatives inevitably causes variance in the solution, and no matter which feature subset to choose as the best, some other good alternatives are going to be missed. In doing so, an opportunity to consider a potentially more appropriate feature set in terms of both the quantitative and qualitative criteria, is missed. Therefore, feature subset selection, which searches for a single best feature subset, is not the most effective problem formulation to address the multicollinearity issue in the context of feature engineering.

According to various embodiments, provided is a hybrid feature selection approach, feature subset ranking, which aims to identify a set of feature subsets and rank each of the feature subsets in the set. The ranked features subsets can be provided to a human expert or algorithm representing the knowledge of a subject matter expert. According to various embodiments, the hybrid feature selection is a non-exhaustive, approximate approach to feature subset ranking that directly identifies as many unique high-ranking subsets of features as possible while avoiding evaluations on low-ranking subsets. The feature subset ranking method described herein is a non-exhaustive, non-randomized method for feature subset ranking, which can efficiently identify multiple unique high-potential subsets of features with a small number of search iterations.

The feature selection process described herein that incorporates feature subset ranking may include software such as an application or a service which may be incorporated within an industrial system or cloud environment such as within a control system, a computer, a server, a cloud platform, a machine, an equipment, a vehicle, a locomotive, an aircraft, a smart structure, and the like. For example, the feature selection process may be part of a larger feature discovery process that is used within predictive analytics for assets and asset performance, as an enabler for a digital twin simulation process or a brilliant manufacturing process, or the like, however, embodiments are not limited thereto. Predictive analytics may generate models that are based on a relation between a particular performance of a unit in a sample and one or more known attributes or features of the unit. In this case, the objective of the model is often to assess the likelihood, or otherwise predict whether a similar unit in a different sample will exhibit the same performance.

While progress with machine and equipment automation has been made over the last several decades, and assets have become ‘smarter,’ the intelligence of any individual asset pales in comparison to intelligence that can be gained when multiple smart devices are connected together, for example, in the cloud. As described herein, an asset is used to refer to equipment and/or a machine used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

For example, an asset can be outfitted with one or more sensors configured to monitor respective operations or conditions thereof. Data from the sensors can be added to the cloud platform. By bringing such data into a cloud-based environment, new software applications and control systems informed by industrial process, tools and expertise can be constructed, and new physics-based analytics specific to an industrial environment can be created. Insights gained through analysis of such data can lead to enhanced asset designs, enhanced software algorithms for operating the same or similar assets, better operating efficiency, enhanced feature evaluation, and the like.

Assets described herein can include or can be a portion of an Industrial Internet of Things (IIoT). An IIoT can connect assets including machines and equipment, such as turbines, jet engines, healthcare machines, locomotives, oil rigs, and the like, to the Internet and/or a cloud, or to each other in some meaningful way such as through one or more networks. The examples described herein can include using a “cloud” or remote or distributed computing resource or service. The cloud can be used to receive, relay, transmit, store, analyze, or otherwise process information for or about one or more assets. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

However, the integration of assets with the remote computing resources to enable the IIoT often presents technical challenges separate and distinct from the specific industry and from computer networks, generally. A given machine or equipment based asset may need to be configured with novel interfaces and communication protocols to send and receive data to and from distributed computing resources. Assets may have strict requirements for cost, weight, security, performance, signal interference, and the like, in which case enabling such an interface is rarely as simple as combining the asset with a general purpose computing device. To address these problems and other problems resulting from the intersection of certain industrial fields and the IIoT, a cloud platform can be provided that can receive and deploy applications from many different fields of industrial technologies.

The Predix™ platform available from GE is a novel embodiment of an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of assets can be uniquely situated to leverage its understanding of assets themselves, models of such assets, and industrial operations or applications of such assets, to create new value for industrial customers through asset insights.

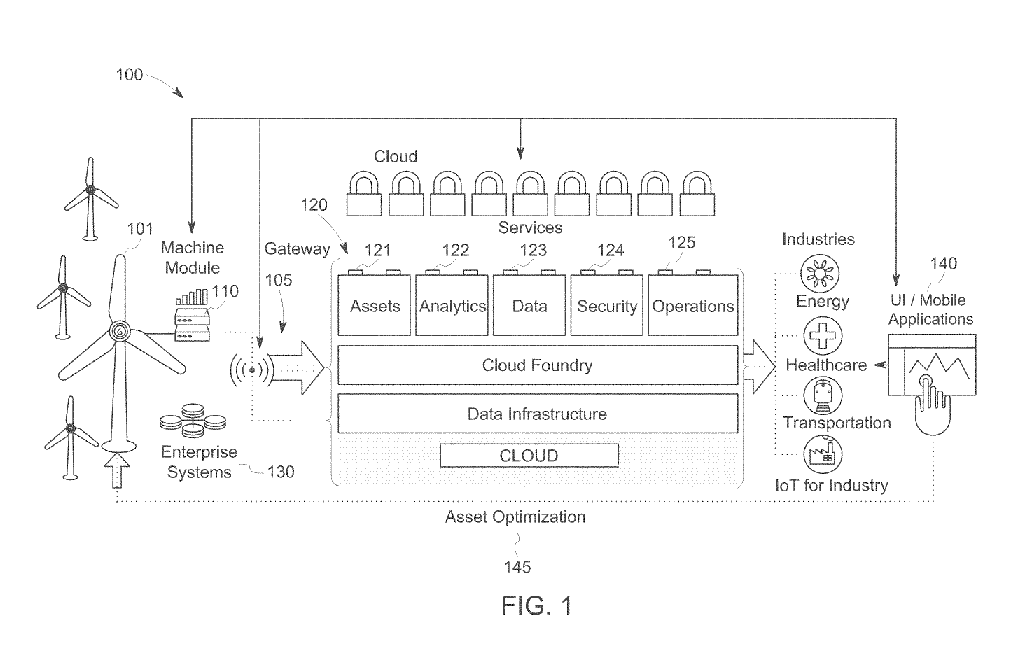

FIG. 1 illustrates a cloud computing environment associated with industrial systems which may implement the feature discovery process described herein. FIG. 1 generally illustrates portions of an asset management platform (AMP) 100. As further described herein, one or more portions of an AMP can reside in a cloud computing system 120, in a local or sandboxed environment, or can be distributed across multiple locations or devices. The AMP 100 can be configured to perform any one or more of data acquisition, data analysis, or data exchange with local or remote assets, or with other task-specific processing devices. The AMP 100 includes an asset community (e.g., gas turbines, wind turbines, healthcare machines, industrial systems, manufacturing systems, oil rigs, etc.) that is communicatively coupled with the cloud computing system 120. In an example, a machine module 110 receives information from, or senses information about, at least one asset member of the asset community, and configures the received information for exchange with the cloud computing system 120. The machine module may be coupled to the cloud computing system 120 or to an enterprise computing system 130 via a communication gateway 105.

The communication gateway 105 may include or may use a wired or wireless communication channel that extends at least from the machine module 110 to the cloud computing system 120. The cloud computing system 120 may include several layers, for example, a data infrastructure layer, a cloud foundry layer, and modules for providing various functions. In FIG. 1, the cloud computing system 120 includes an asset module 121, an analytics module 122, a data acquisition module 123, a data security module 124, and an operations module 125, but the embodiments are not limited thereto. Each of the modules includes or uses a dedicated circuit, or instructions for operating a general purpose processor circuit, to perform the respective functions. In an example, the modules 121-125 are communicatively coupled in the cloud computing system 120 such that information from one module can be shared with another. In an example, the modules 121-125 are co-located at a designated datacenter or other facility, or the modules 121-125 can be distributed across multiple different locations.

An interface device 140 (e.g., user device, workstation, tablet, laptop, appliance, kiosk, and the like) can be configured for data communication with one or more of the machine module 110, the gateway 105, and the cloud computing system 120. The interface device 140 can be used to access analytical applications deployed on the cloud computing system 120 to monitor or control one or more assets. The feature discovery process according to various embodiments may be implemented within the applications for monitoring and controlling these assets. The interface device 140 may also be used to develop and upload applications to the cloud computing system 120. In an example, information about the asset community may be presented to an operator at the interface device 140. The information about the asset community may include information from the machine module 110, information from the cloud computing system 120, and the like. The interface device 140 can include options for optimizing one or more members of the asset community based on analytics performed at the cloud computing system 120.

The example of FIG. 1 includes the asset community with multiple wind turbine assets, including the wind turbine 101. However, it should be understood that wind turbines are merely used in this example as a non-limiting example of a type of asset that can be a part of, or in data communication with, the first AMP 100. Examples of other assets include gas turbines, steam turbines, heat recovery steam generators, balance of plant, healthcare machines and equipment, aircraft, locomotives, oil rigs, manufacturing machines and equipment, textile processing machines, chemical processing machines, mining equipment, and the like.

FIG. 1 further includes the device gateway 105 configured to couple the asset community to the cloud computing system 120. The device gateway 105 can further couple the cloud computing system 120 to one or more other assets or asset communities, to the enterprise computing system 130, or to one or more other devices. The AMP 100 thus represents a scalable industrial solution that extends from a physical or virtual asset (e.g., the wind turbine 101) to a remote cloud computing system 120. The cloud computing system 120 optionally includes a local, system, enterprise, or global computing infrastructure that can be optimized for industrial data workloads, secure data communication, and compliance with regulatory requirements.

The cloud computing system 120 can include the operations module 125. The operations module 125 can include services that developers can use to build or test Industrial Internet applications, and the operations module 125 can include services to implement Industrial Internet applications, such as in coordination with one or more other AMP modules. In an example, the operations module 125 includes a microservices marketplace where developers can publish their services and/or retrieve services from third parties. In addition, the operations module 125 can include a development framework for communicating with various available services or modules. The development framework can offer developers a consistent look and feel and a contextual user experience in web or mobile applications. Developers can add and make accessible their applications (services, data, analytics, etc.) via the cloud computing system 120.

Information from an asset, about the asset, or sensed by an asset itself may be communicated from the asset to the data acquisition module 123 in the cloud computing system 120. In an example, an external sensor can be used to sense information about a function of an asset, or to sense information about an environment condition at or near an asset. The external sensor can be configured for data communication with the device gateway 105 and the data acquisition module 123, and the cloud computing system 120 can be configured to use the sensor information in its analysis of one or more assets, such as using the analytics module 122. Using a result from the analytics module 122, an operational model can optionally be updated, such as for subsequent use in optimizing the first wind turbine 101 or one or more other assets, such as one or more assets in the same or different asset community. For example, information about the wind turbine 101 can be analyzed at the cloud computing system 120 to inform selection of an operating parameter for a remotely located second wind turbine that belongs to a different asset community.

The cloud computing system 120 may include a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA mappings to underlying infrastructure. This configuration can be useful when an application requires an underlying hardware configuration. The provisioning management and pooling of resources can be done at a granular level, thus allowing optimal resource allocation. In addition, the asset cloud computing system 120 may be based on Cloud Foundry (CF), an open source PaaS that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The cloud computing system 120 can include a data services module that can facilitate application development. For example, the data services module can enable developers to bring data into the cloud computing system 120 and to make such data available for various applications, such as applications that execute at the cloud, at a machine module, or at an asset or other location. In an example, the data services module can be configured to cleanse, merge, or map data before ultimately storing it in an appropriate data store, for example, at the cloud computing system 120. A special emphasis may be placed on time series data, as it is the data format that most sensors use.

Raw data may be provided to the cloud computing system 120 via the assets included in the asset community and accessed by applications deployed on the cloud computing system 120. During operation, an asset may transmit sensor data to the cloud computing system 120 and prior to the cloud computing system 120 storing the sensor data, the sensor data may be filtered and analyzed using the feature discovery process described herein to generate more efficient and accurate analyzations and predictions of the data. In some embodiments, the feature discovery process may be implemented as a software program stored within the cloud computing system 120, or another device such as a computer incorporated with the asset itself, the enterprise computing system 130, the interface device 140, or another device not shown in FIG. 1.

Having a set of good features is the key to high prediction performance (accuracy and robustness) of predictive models. Thus, discovering salient features is a critical task in creating machine learning & data mining models as well as in developing reliable analytics solutions. The example embodiments are directed to a system and method for determining and ranking available features for feature selection. For example, a predetermined number of features can be identified and ranked and output to a subject matter expert who can make the ultimate decision (i.e., feature selection) as to which features are best for the particular problem or solution involved.

Prior to the embodiments herein, feature subset ranking has been overlooked in research. A few methods that have been previously used for feature subset selection have the potential to be adapted for and incorporated within a process for feature subset ranking with minor modifications. For example, all-subset regression may be implemented herein which includes a selection process which regresses with all possible subsets of candidate features and selects the one that leads to the best regression model. As another example, bootstrapping may be implemented herein which can find many best feature subsets, each on a bootstrap of the full feature set, where the process picks the best or a subset of best features. As yet another example, global optimization may be implemented herein which includes a search for the best feature subset by optimizing a certain loss function using global optimization algorithms, such as genetic algorithms, simulated annealing, etc.

All-subset regression is an exhaustive approach. Because all possible subsets are evaluated, it does not add complexity to rank all possible subsets instead of picking the top-ranking one. All-subset regression might be the only approach that can guarantee an identification of best choice for feature subsets, however, it is practical only under constraint situations such as when the size of the candidate feature set is small and/or when the size of the selected feature subset is constrained to a small number. In contrast, this method can quickly become unmanageable when the problem scales up and larger sizes of features are considered.

Bootstrapping and global optimization approaches, if modified to retain all traversed feature subsets, can produce an approximate to the result produced by the exhaustive approach. This approximation is only useful as long as the high-ranking feature subsets are covered in the approximated rank list, because, in the end, only the high-performing feature subsets are meaningful for human experts to review. However, bootstrapping and global optimization approaches, even if they may work well to find the single best feature subset, might not efficiently find multiple, let alone, many unique reasonably-good feature subsets without significantly increasing the number of iterations. This is because many of those search iterations tend to find the same best feature subset rather than different ones, causing a waste in the search time. After all, those approaches have been designed to converge to the optimal solution rather than to diversify the solutions.

The example embodiments provide a non-exhaustive, approximate approach to feature subset ranking which can directly identify many unique high-ranking subsets while avoiding or wasting resources on evaluations of low-ranking subsets. Along this line, the feature subset ranking described herein is a non-exhaustive, non-randomized method for feature subset ranking, which can efficiently identify multiple unique high-potential subsets through a small number of search iterations.

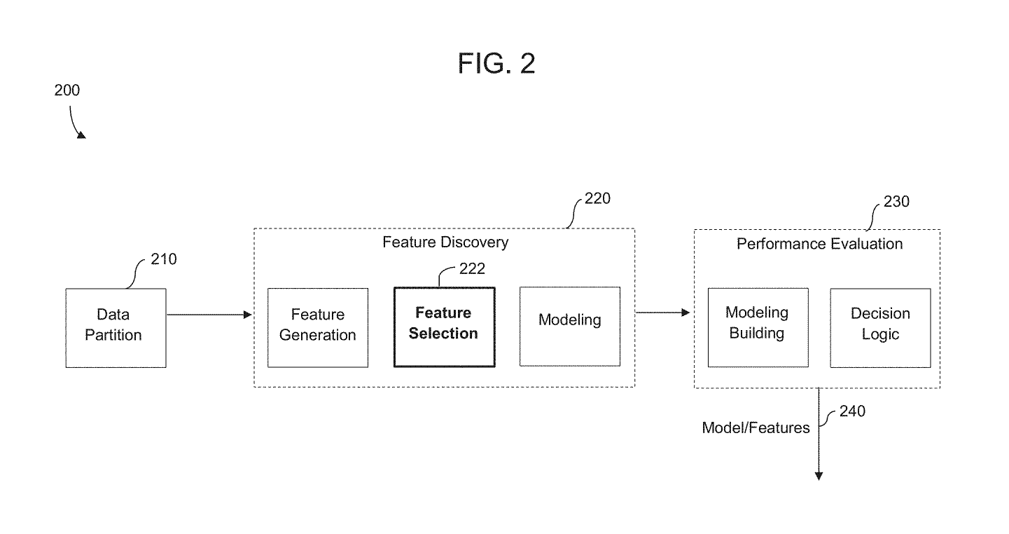

FIG. 2 illustrates an example of a feature discovery process 200 in accordance with an example embodiment. Referring to FIG. 2, a feature discovery pipeline is shown and includes several different functional building blocks, including data partitioning 210, feature discovery 220 and performance evaluation 230. In this example, an output 240 may include a feature set that is generated based on the feature discovery pipeline and used for various purposes including analytics such as predictive analytics for controlling and/or monitoring an asset. In the example of FIG. 2, the feature discovery block 220 further includes feature generation, feature selection 222, and modeling. According to various aspects, the feature subset selection and ranking process may be incorporated within the feature discovery 220, and in this example, within the feature selection 222.

Each step of the pipeline involves multiple possible design choices as well as different design parameters associated with each of the design choices. For a given problem or application, designing a feature discovery pipeline is essential in order to find the best design choices and the corresponding design parameters for each of the processes of the pipeline by searching across all instantiations (all combinations of design choices and their corresponding design parameters). However, this huge combinatorial search space makes optimization computationally expensive and impractical in real-world applications. Plus, the objective function of the optimization may not be easily evaluated. As the result, discovering features through analytical optimization is practically impossible.

In the example of FIG. 2, during data partition 210, a partition method may be provided from domain knowledge based on an asset associated with the feature discovery process or based on time. The data may be transformed from the time domain into the frequency domain where features can be generated. During feature generation, domain based features, constraints, variables, feature generation algorithms, and the like, may be provided from domain knowledge. Furthermore, a sanity check may be performed on the generated features based on domain knowledge. During feature selection 222, feature filtering criteria, subset selection criteria, feature suggestions, feature evaluation, visualization of features, suggested adjustments for feature generation, and the like, can be performed based on the feature subset ranking process described herein. The selected features may be used to build a model such as an analytical or predictive model for the asset.

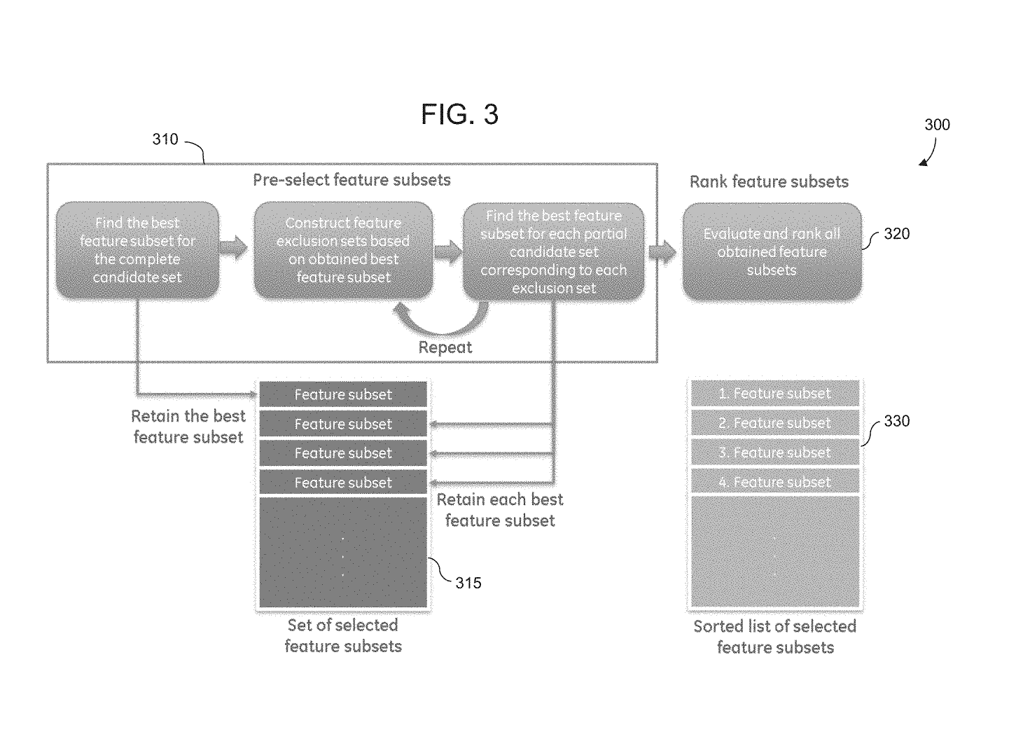

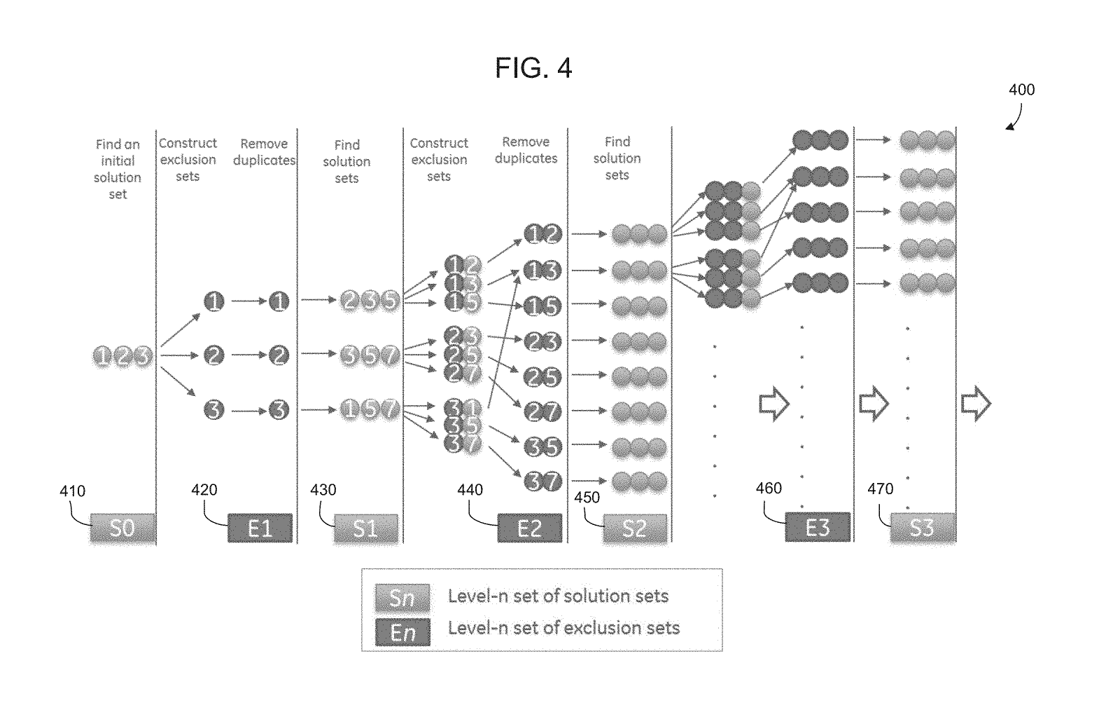

FIG. 3 illustrates a feature subset selection and ranking process 300 in accordance with an example embodiment, and FIG. 4 illustrates a feature subset selection process 400 corresponding to the pre-selection process 310 shown in FIG. 3, in accordance with an example embodiment. Referring to FIG. 3, the process includes a feature subset pre-selection 310 that may non-exhaustively populate multiple feature subsets that are likely to rank high among all possible feature subsets, and a feature subset ranking 320 that may evaluate and rank all pre-selected feature subsets and provide a list of ranked subsets 330. As described herein, each feature subset may include one or more features.

The feature subset pre-selection 310 may search for potential and likely feature subsets, iteratively. For example, the feature subset pre-selection 310 may be repeated until a predetermined number of features are identified, until a predetermined number of exclusion sets have been identified, and/or the like. In this example, the feature subset pre-selection 310 may include searching for a best feature subset given a certain candidate feature set and base routine, constructing sets of features for exclusion from the full candidate sets based on the best feature subset previously found, and continue to search for the best feature subset from a partial candidate feature set. Here, each partial candidate feature set has all respective features excluded corresponding to an exclusion set. As new best feature subsets or additional feature subsets are discovered, they are added to the set of selected feature subsets in 315. The iteration in 310 and 315 may be continued until a predetermined (e.g., predefined) maximum number of excluded features is reached. Then, the feature subsets in 315 that are obtained during the iterative search process 310 are collected and merged as the preselected set of feature subsets.

In 320, the preselected feature subsets are evaluated based on one or more performance criteria to get a performance score for each, by which those feature subsets can be ranked. The outcome of 320 may be a non-exhaustive list of top-performing feature subsets with scores, which resembles the outcome from a feature ranking algorithm, but in a multivariate way.

In this example, the idea behind the preselection, in 310, is based on the following hypothesis: if arbitrary 1 through m features are exhaustively excluded from the candidate feature set, and a traditional feature subset selection algorithm is applied to get a best feature subset for each partial candidate set, then, as m increases, the unique best feature subsets obtained in this way will gradually converge to the high-ranking feature sets obtained from the exhaustive approach. By intuition, the process of excluding variables from the candidate set breaks the dominance of certain features while selecting the best feature subset, allowing alternative subsets to be selected. As more features are excluded, more unique subsets are ranked on top at local selection steps and are listed within the global pool of high-potential subsets.

According to various embodiments, the exclusion sets are constructed in a unique fashion. Exhaustively enumerating all possible feature subsets to exclude is as impractical as attempting to identify all possible feature subsets for inclusion because the number of options grows at factorial rate. Randomly excluding feature subsets shares the same drawback as randomly generating (bootstrapping) candidate feature subsets discussed previously. According to various embodiments, the method and system herein use a non-exhaustive, deterministic algorithm to generate exclusion sets. The algorithm can produce equivalent results to the exhaustive exclusion approach for the same size of exclusion set, but with a lot less invocation of the feature subset selection routine.

Referring to FIG. 4, during feature subset pre-selection 310 shown in FIG. 3, the same feature subset selection algorithm, referred to as the base routine, can be invoked multiple times to find a single best feature subset for a given candidate set, either complete candidate set or partial candidate set. In this example, a subset of features is frequently excluded from the full candidate set to create a partial candidate set, and the base routine is defined by the following Equation 1.

S=fss1(X,E) Equation 1

Where X is the candidate set, with all the features to select from, E is the exclusion set, with features to exclude from the candidate set, E⊂X, and S is the solution set, i.e., the best feature subset, where S⊂X−E. The actual feature subset selection algorithm used to implement the base routine has many options and is further described, later.

Referring to FIG. 4, the process 400 of the pre-selection algorithm includes running the base routine on the complete candidate feature set to obtain a solution set, in 410, and in 420, constructing a plurality of exclusion sets from the obtained solution set. Here, each exclusion set may consist or otherwise include one feature drawn from the solution set. In 430, the base routine is run on a plurality of partial candidate sets corresponding to each of the exclusion sets. Here, the base routine may be run once for each respective partial candidate set. Each exclusion set leads to one new solution set. For each pair of exclusion set and solution set, in 440 a new batch of exclusion sets is constructed. Here, each new exclusion set may consist of the original exclusion set from which it depends and one additional feature drawn from the solution set. Furthermore, all new exclusion sets may be merged into a single set of new exclusion sets, with duplicated ones removed. In 450, same as in 430, the base routine is run on another group of respective partial candidate sets corresponding to each of the exclusion sets. Here, each exclusion set leads to one new solution set. In some embodiments, in step 460, previous steps 440 and 450 are repeated until the number of features in the exclusion sets reaches a specified search depth m, and in 470, all unique solution sets obtained are collected.

Each of the solutions sets may be evaluated by a predefined performance criteria (320 shown in FIG. 3), to determine a performance score. Furthermore, a ranking of the solutions sets (i.e., feature subsets) can be determined based on the performance scores. The choice of the performance criteria has freedom. For example, a generalized linear model can be used with each feature subset and commonly used model selection criteria such as AIC (Akaike Information Criterion) or BIC (Bayesian Information Criterion) may be computed for each model. If the size of selected feature subset is fixed a prior, R-squared can be selected by default as the performance criteria for a regression problem, or use various metrics derived from a confusion matrix for a classification problem.

According to various aspects, the choice of a feature subset selection algorithm for the base routine has freedom, too. With the two-step approach for feature subset ranking, it is not necessary to enforce the pre-selection step and the final evaluation step to use identical selection/ranking criteria, although, intuitively, using similar criteria may avoid discrepancy between the preselected best subsets and their actual performance. Examples of linear model based feature subset selection algorithms include backward elimination, forward selection, LASSO (least absolute shrinkage and selection operator), forward stagewise regression, LAR (least angle regression), and the like, although many more non-linear feature subset selection algorithms are applicable as well.

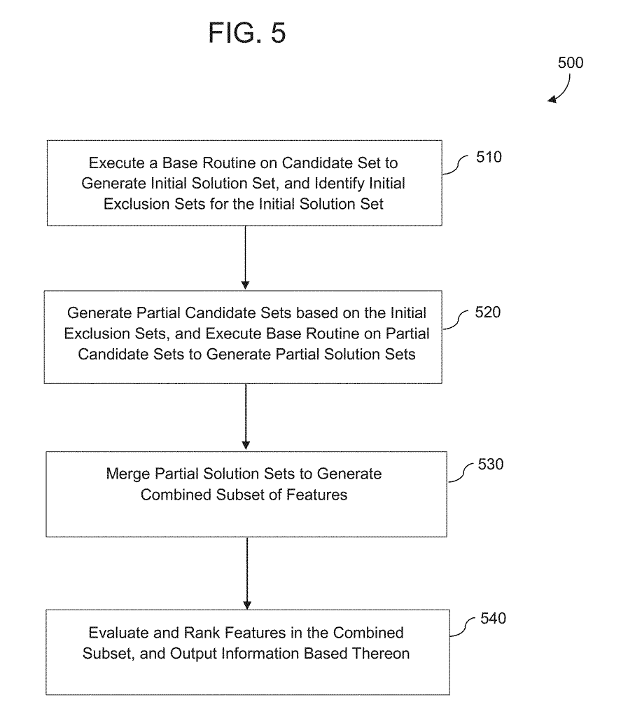

FIG. 5 illustrates a method 500 for selecting and ranking feature subsets in accordance with an example embodiment. For example, the method 500 may be performed by a user device such as a laptop, mobile phone, a tablet, a desktop, an appliance, a kiosk, a television, a work station, and the like. As another example, the method 500 may be performed by a cloud computing system, a server, or another device or distributed group of devices that are connectable over a network. Referring to FIG. 5, in 510, the method includes executing a base routine on a candidate set of features to generate an initial solution set, and identifying a plurality of initial exclusions sets for the initial solution set. For example, the initial solution set may be the best possible feature subset, a feature subset that satisfies predetermined criteria, and the like, discovered by executing the base routine with the candidate set of features.

Here, the candidate set may refer to a set of data that includes all possible features that are available and which may be analyzed for feature selection and evaluation, and the base routine may include a feature subset selection method that selects one or more features from the candidate set to be included in the initial solution set. The candidate set may be generated based on sensor data attached to or about an asset. The sensor data may be gathered from physical sensors on a real asset or virtual sensors on a virtual asset. In order to generate the candidate features, the raw sensor data (e.g., time series data) may be transformed, for example, into the frequency domain. The initial exclusions sets may be generated to include one unique feature from the initial solution set.

In 520, the method includes generating a plurality of partial candidates sets of the candidate set based on the plurality of initial exclusion sets, and executing the base routine on the plurality of partial candidate sets to discover a plurality of additional solution sets. For example, each initial exclusion set can be used to generate a corresponding partial candidate set, and the base routine can be executed on each partial candidate set to discover an additional solution set corresponding to each partial candidate set. In 530, the method further includes merging the discovered solutions sets to generate a combined set of unique feature subsets, and, in 540, determining a ranking for each feature subset in the combined set of feature subsets and outputting information concerning the determined rankings for display on a display device. For example, the merging may include combining all unique solution sets from among the initial solution set and the additional solution sets to generate the combined set of feature subsets.

In some embodiments, the generating in 520 may further include pairing together each exclusion set with its corresponding solution set, and identifying a plurality of additional exclusion sets for each pair, wherein each additional exclusion set includes the initial exclusion set in the pair and one additional feature from the corresponding paired solution set. In some embodiments, the generating in 520 may further include generating a plurality of additional partial candidate sets based on the plurality of additional exclusion sets, executing the base routine on the plurality of additional partial candidate sets to discover a second plurality of additional solution sets, and combining the discovered second plurality of solutions sets with the previous solution sets to generate the combined set of unique feature subsets. Also, the generating may further include merging the plurality of exclusion sets into a combined set of unique exclusion sets, and repeatedly performing the generating until the number of features in a single exclusion set reaches a predetermined threshold.

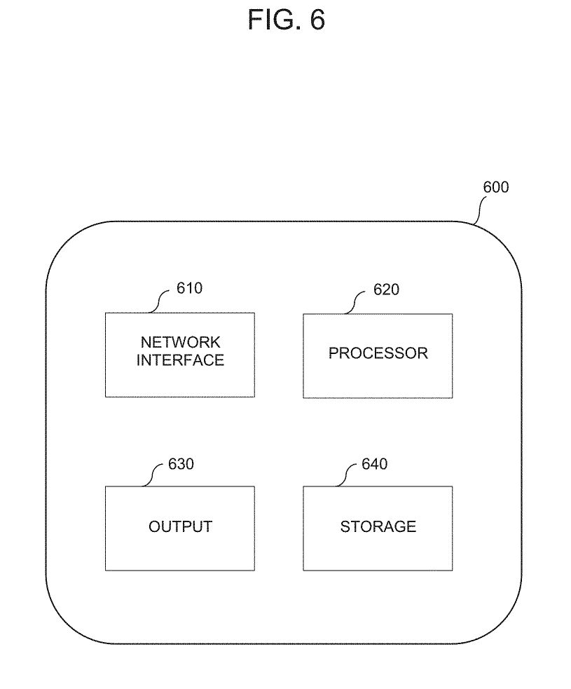

FIG. 6 illustrates a computing device 600 for selecting and ranking feature subsets in accordance with an example embodiment. For example, the computing device 600 may be a user device such as a computer, laptop, mobile device, tablet, etc., a server, a cloud computing system, and the like. The computing device 600 may perform the method 500 of FIG. 5. Referring to FIG. 6, the computing device 600 includes a network interface 610, a processor 620, an output 630, and a storage device 640. Although not shown in FIG. 6, the device 600 may include other components such as a display, an input unit, a receiver/transmitter, and the like. In this example, the processor 620 may control the overall operation of one or more of the components of the computing device 600 or may be substituted for one or more of the components.

The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The output 630 may output data to an embedded display of the device 600, an externally connected display, a cloud, another device, and the like. The storage device 640 is not limited to any particular storage device and may include any known memory device such as RAM, ROM, hard disk, and the like.

According to various embodiments, the processor 620 may execute a base routine on a candidate set of features to generate an initial solution set, and identify a plurality of initial exclusions sets for the initial solution set. In some embodiments, the processor 620 may further generate a plurality of partial candidates sets of the candidate set based on the plurality of initial exclusion sets, execute the base routine on the plurality of partial candidate sets to discover a plurality of additional solution sets, combine the discovered solutions sets to generate a combined set of unique feature subsets, and determine a ranking for each feature subset in the combined set of feature subsets. Here, the output 630 may output information concerning the determined rankings for display on a display device for example, graphs, charts, listings of the features, score/ranking, and the like.

In some embodiments, the processor 620 may pair together each exclusion set with its corresponding solution set, and identify additional exclusion sets for each solution set. For example, each additional exclusion set may include the initial exclusion set in the pair and one additional feature from the corresponding paired solution set. In some embodiments, the processor 620 may generate a plurality of additional partial candidate sets based on the plurality of additional exclusion sets, execute the base routine on the plurality of additional partial candidate sets to discover a second plurality of additional solution sets, and combine the discovered second plurality of solutions sets with the previously discovered solution sets to generate the combined set of unique feature subsets. In addition, the processor 620 may merge the plurality of exclusion sets into a combined set of unique exclusion sets, and repeatedly perform the generating until the number of features included in a single exclusion set reaches a predetermined threshold.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to various examples of the application. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A method for selecting and ranking feature subsets, comprising:
executing a base routine on a candidate set of features to generate an initial solution set, and identifying a plurality of initial exclusions sets for the initial solution set;
generating a plurality of partial candidates sets of the candidate set based on the plurality of initial exclusion sets, executing the base routine on the plurality of partial candidate sets to discover a plurality of additional solution sets, and combining the discovered solution sets to generate a combined set of feature subsets; and
determining a ranking for each feature subset in the combined set of feature subsets and outputting information concerning the determined rankings of the feature subsets for display on a display device.

2. The method of claim 1, wherein the generating further comprises pairing together each exclusion set with its corresponding solution set, and identifying a plurality of additional exclusion sets for each pair, wherein each additional exclusion set comprises the initial exclusion set in the pair and one additional feature from the corresponding paired solution set.

3. The method of claim 2, wherein the generating further comprises generating a plurality of additional partial candidate sets based on the plurality of additional exclusion sets, executing the base routine on the plurality of additional partial candidate sets to discover a second plurality of additional solution sets, and combining the discovered second plurality of additional solutions sets to generate the combined set of feature subsets.

4. The method of claim 2, wherein the generating further comprises merging the plurality of exclusion sets into a combined set of unique exclusion sets, and repeatedly performing the generating until the number of unique features included in a single exclusion set reaches a predetermined threshold.

5. The method of claim 1, wherein each initial exclusion set comprises one unique feature from the initial solution set.

6. The method of claim 1, wherein the candidate set is based on a set of data features received from one or more sensors attached to an asset.

7. The method of claim 1, wherein the base routine comprises an automated feature subset selection method that selects one or more features from the candidate set to be included in a solution set.

8. The method of claim 1, wherein each feature subset included in the combined set of feature subsets comprises a unique solution set, and the feature subsets are ranked based on a performance criteria associated with features included therein.

9. A computing system comprising:
a storage device;
a processor configured to execute a base routine on a candidate set of features to generate an initial solution set, and identify a plurality of initial exclusions sets for the initial solution set, wherein the processor is further configured to:
generate a plurality of partial candidates sets of the candidate set based on the plurality of initial exclusion sets,
execute the base routine on the plurality of partial candidate sets to discover a plurality of additional solution sets,
combine the discovered solution sets to generate a combined set of feature subsets, and
determine a ranking for each feature subset in the combined set of feature subsets; and
an output configured to output information concerning the determined rankings of the feature subsets for display on a display device.

10. The computing system of claim 9, wherein the processor is further configured to pair together each exclusion set with its corresponding solution set, and identify a plurality of additional exclusion sets for each pair, wherein each additional exclusion set comprises the initial exclusion set in the pair and one additional feature from the corresponding paired solution set.

11. The computing system of claim 10, wherein the processor is further configured to generate a plurality of additional partial candidate sets based on the plurality of additional exclusion sets, execute the base routine on the plurality of additional partial candidate sets to discover a second plurality of additional solution sets, and combine the discovered second plurality of additional solution sets to generate the combined set of feature subsets.

12. The computing system of claim 10, wherein the processor is further configured to merge the plurality of exclusion sets into a combined set of unique exclusion sets, and repeatedly perform the generating until the number of unique features in a single exclusion set reaches a predetermined threshold.

13. The computing system of claim 9, wherein each initial exclusion set comprises one unique feature from the initial solution set.

14. The computing system of claim 9, wherein the candidate set is based on a set of data features received from one or more sensors attached to an asset.

15. The computing system of claim 9, wherein the base routine comprises an automated feature subset selection method that selects one or more features from the candidate set to be included in a solution set.

16. The computing system of claim 9, wherein each feature subset included in the combined set of feature subsets comprises a unique solution set, and the feature subsets are ranked by the processor based on a performance criteria associated with features included therein.

17. A non-transitory computer readable storage medium having stored therein instructions that when executed cause a processor to perform a method for selecting and ranking feature subsets, comprising:
executing a base routine on a candidate set of features to discover an initial solution set, and identifying a plurality of initial exclusions sets for the initial solution set;
generating a plurality of partial candidates sets of the candidate set based on the plurality of initial exclusion sets, executing the base routine on the plurality of partial candidate sets to discover a plurality of additional solution sets, and combining the discovered solutions sets to generate a combined set of feature subsets; and
determining a ranking for each feature subset in the combined set of feature subsets and outputting information concerning the determined rankings of the feature subsets for display on a display device.

18. The non-transitory computer readable medium of claim 17, wherein the generating further comprises pairing together each exclusion set with its corresponding solution set, and identifying a plurality of additional exclusion sets for each pair, wherein each additional exclusion set comprises the exclusion set in the pair and one additional feature from the corresponding paired solution set.

19. The non-transitory computer readable medium of claim 18, wherein the generating further comprises generating a plurality of additional partial candidate sets based on the plurality of additional exclusion sets, executing the base routine on the plurality of additional partial candidate sets to discover a second plurality of additional solution sets, and combining the discovered second plurality of additional solutions sets to generate the combined set of feature subsets.

20. The non-transitory computer readable medium of claim 17, wherein the generating further comprises merging the plurality of exclusion sets into a combined set of unique exclusion sets, and repeatedly performing the generating until the number of unique features included in any exclusion set reaches a predetermined threshold.
